(19) United States
(12) Patent Application Publication
(10) Pub. No.: US 2005/0229527 A1
(43) Pub. Date: Oct. 20, 2005

(54) Artifical wall

(76) Inventor: Bryan M. Buchi, West Jordan, UT (US)

Correspondence Address: Starkweather & Associates, 9035 S 1300 E, Suite 200, Sandy, UT, 84094, US

(21) Appl. No.: 10/827,468

(22) Filed: Apr. 19, 2004

(51) Int. Cl. B29C 67/00; E04C 2/04; E04B 5/04

(52) U.S. Cl. 52/612

(57) ABSTRACT

A decorative liner configured to secure to an underlying structure to beautify the underlying structure. A mold is coated with a urethane release formula. Design colors are sprayed onto a pattern of the mold to reflect a natural rock appearance. Polyurethane is sprayed over the colors and onto the mold according to well known molding techniques. The liner is removed and touched up for imperfections and coated with an ultraviolet coating to protect against fading. The underlying structure is measured and the liner is cut to match the underlying structure dimensions. Screws fasten the liner to the underlying structure. The screw heads are painted to match the appearance of the liner. Where first and second liners meet, particularly at a corner, the first liner is trimmed to match the outline of the second liner. The liners are glued together where the first and second liners meet. The first liner is painted to match rock protrusions where the first and second liners meet.

### BACKGROUND OF THE INVENTION

1. Field of the Invention

This invention relates in general to artificial walls. Specifically, the present invention relates to an artificial wall for covering an existing wall, or the like.

2. Description of the Related Art

All homes are built on foundations. Nearly every home includes a section of the foundation that is clearly visible, especially on homes with basements. Unfortunately, while the rest of the home is painted, sided, or covered with stucco, the unsightly cement foundation is left unimproved.

Some home owners have spent thousands of dollars, or more, landscaping their yards to hide the cement foundation. Rocks, or stones, have emerged as a popular way of improving the appearance of one's home or property and have been used in landscaping for aesthetic purposes for years. Rocks are used to form birdbaths, hollow rock planters of various sizes, artificial waterfalls, decorative fences, walls, and rock gardens. The use of rocks for aesthetic purposes is very popular.

Although rocks are very popular, there are numerous disadvantages to using rocks. Specifically, natural rocks are heavy, of random sizes and shapes, and may have to be transported to great distances from their natural source of origin to the place of intended use.

Transportation costs can often exceed the labor costs of quarrying the rock and handling it in the final placement on the landscaped grounds.

Another problem with natural rocks, particularly large ones, is that they are not easily handled. Usually there are no natural handholds or attachment points for lifting and placing them, and as a result, large, heavy rocks must be handled with hoists equipped with slings or using earth moving equipment. This is difficult, sometimes dangerous, and always time consuming.

Additionally, it is often difficult to use natural rock incorporated into dimensional structures, such as fencing, lamp posts, barbecue holders, and even furniture, such as rock tables and benches. In order to use the natural rock in these circumstances, it is often necessary to employ the skills and equipment of a stone cutter.

A further problem with natural rocks is that they do not generally serve as an adequate form of foundation for structures. Homes must be built on foundation material that is sure to pass certain rules and regulations. Rocks gathered from distant quarries lack the kind of quality control to provide sufficient confidence that the rocks will maintain structural integrity under heavy loads. Accordingly, it is often necessary to use a tried-and-true material, such as cement, for the foundation, even though cement may not be as aesthetically pleasing.

Still another problem with natural rocks is the cost associated with hiring professionals to build rock structures for design purposes, or to make a home, or the like, more aesthetically attractive. Many people prefer the appearance of rock structures over the appearance of cement or metal, however, many cannot afford that extra expense or upgrade, especially at the time a new home is being built.

Accordingly, what is needed is an artificial rock wall which simulates the appearance, texture, durability, and aesthetic integrity of a natural rock wall, which can be formed in a mold for any desired purpose, and attached to an underlying structure, such as a foundation of a home.

### SUMMARY OF THE INVENTION

The present invention has been developed in response to the present state of the art, and in particular, in response to the problems and needs in the art that have not yet been fully solved by currently available artificial walls. Accordingly, the present invention has been developed to provide an artificial rock wall designed to exhibit natural rock characteristics and to maintain original color, shape, and form.

More specifically, the present invention provides an artificial wall configured to fasten to an underlying structure, such as a foundation of a home, to beautify the underlying structure. A mold is coated with a urethane release formula. Design colors are sprayed onto a pattern of the mold to reflect a natural rock appearance. Polyurethane is sprayed over the colors and onto the mold and cured according to well known mold procedures. The artificial wall is removed and touched up for imperfections and coated with an ultraviolet coating to protect against fading. An underlying structure is measured and the artificial wall is cut to match the structure's dimensions. Adjoining pieces of the artificial wall are lined up and the adjoining pieces are trimmed and fastened together. Screws fasten the artificial wall to the underlying structure. The screw heads are caulked and painted to match the appearance of the artificial wall.

Accordingly, there are several features and advantages of the present invention. One feature and advantage of the present invention creates an artificial rock wall, which reflects the appearance and texture of a desired natural rock wall, which can be formed in a mold for any shape and design. Another feature and advantage of the present invention is a method by which the artificial rock wall is secured to adjoining artificial walls and to underlying structures.

Another feature and advantage of the present invention provides for artificial rock platforms that may be attached to an underlying structure at any time, even years after the structures were built.

Another feature and advantage of the invention provides an artificial rock platform with long lasting aesthetic characteristics, such that the colors maintain their original appearance, and enduring physical characteristics, such that the artificial rock platform maintains the original strength, toughness, and integrity.

Yet another feature and advantage of the invention eliminates the concerns associated with having a potentially dangerous rock structure where a rock may come loose and cause serious bodily injury. Another feature and advantage of the invention provides an artificial rock platform that may be easily applied to a structure without the need for specialized skills acquired through years of practice and labor. Another feature and advantage of the invention eliminates the need to transport large and heavy rocks great distances. Another feature and advantage of the present invention removes the unsightly appearance of cement structures, for example, foundations of homes.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an illustration of a typical artificial wall including general patterns according to one embodiment of the present invention;

FIG. 2 illustrates a liner secured to one side of a structure and preparing to receive a second liner at a corner of the structure according to one embodiment of the present invention;

FIG. 3 illustrates a top view of a liner secured to a structure and preparing to receive a second liner at a corner of the structure according to one embodiment of the present invention;

FIG. 4 illustrates both liners secured to a structure, and an outline of one of the liners, according to one embodiment of the present invention;

FIG. 5 illustrates a top view of the liners secured to a structure according to one embodiment of the present invention;

FIG. 6 illustrates both liners secured to the structure and to each other at a corner according to one embodiment of the present invention; and

FIG. 7 illustrates a top view of the liners secured to a structure and to each other at a corner according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

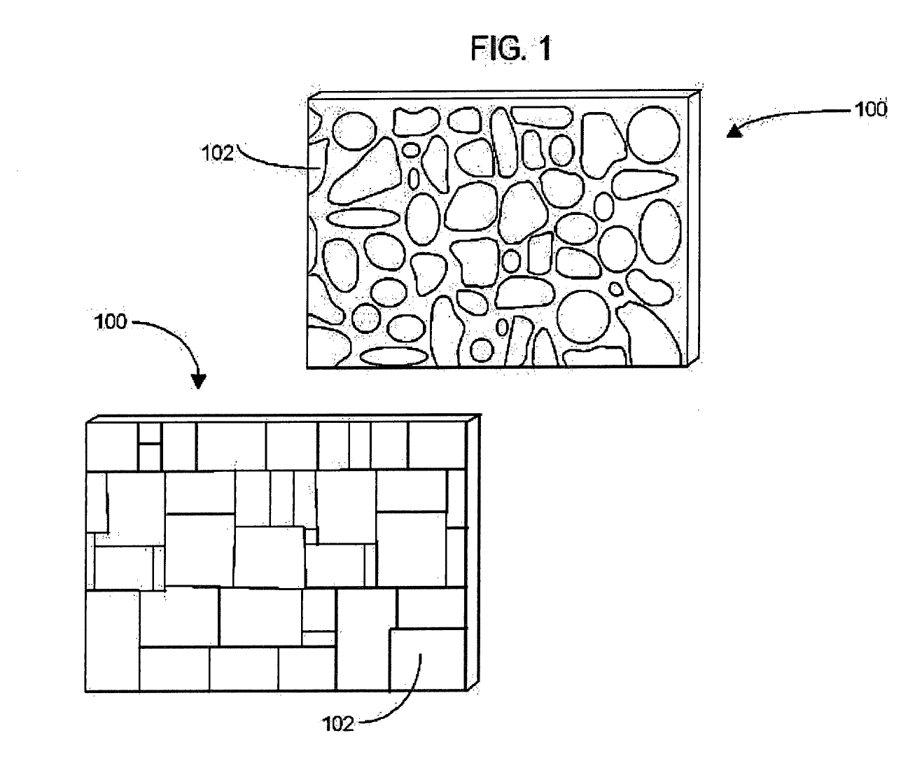

FIG. 1 illustrates embodiments of typical artificial walls 100 including wall patterns according to the present invention. The artificial wall 100 may be generally flat and include a pattern of artificial rocks on one side designed to reflect a natural rock wall or rock structure. The pattern, such as round shaped rocks, square rocks, rectangular rocks, river rocks, granite, slate, brick, wood paneling, stucco, etc., may be designed to reflect any type of surface.

The artificial wall 100 may be comprised of any type of material, including plastic, rubber, wood, ceramic, etc. In this embodiment, the artificial wall 100 is polyurethane and formed on a mold according to well known mold techniques. The mold is coated with a urethane release, such as BSP FV 1622, which can be purchased from local dealers. Preferably, before spraying the mold with polyurethane, the mold is painted with alkyd based paint so that no significant painting is required when the artificial wall 100 is removed. The alkyd based paint reacts well with the polyurethane during the curing period of the polyurethane, which improves weatherability. The type of pattern determines the color of the paint to be applied to the mold. A skilled artisan will recognize that particular colors, hues, and shades are generally used for particular patterns. For instance, a skilled artisan will recognize that to give the artificial wall 100 a brick appearance, the mold may be painted red with gray lines to give the cement look between the bricks. To give the artificial wall 100 a granite appearance the mold may be painted gray. Similarly, a skilled artisan will recognize that multiple colors may be used to give each rock a natural look and to match the three-dimensional aspects of the artificial wall 100.

In a preferred embodiment, after the mold has been painted to provide a natural look, the mold is sprayed with a combination of HYS DX HT-2090F A and HYS DX HT-2090F B natural polyurethane. These polyurethane products may be purchased from local dealers. The mold is sprayed with sufficient polyurethane to give the artificial wall 100 enough structural integrity when it is removed from the mold to prevent significant sagging when the artificial wall 100 is secured to an underlying structure. In this embodiment, the artificial wall 100 is approximately one inch thick at the edges of the artificial wall 100. In another embodiment the artificial wall 100 may be thicker or thinner. In another embodiment, rigid members, screen mesh, or mounting plates may be integrated into the artificial wall 100 to add stiffness to the artificial wall 100 and to improve mounting strength.

After the artificial wall 100 has cured in the mold according to well known techniques, the artificial wall 100 is peeled from the mold and any imperfections are repaired. For instance, it is possible that the paint did not stick to the artificial wall 100 or the colors may need touch-up. A polyurethane ultraviolet layer is applied to eliminate paint fading. The polyurethane ultraviolet layer materials may be purchased from local dealers.

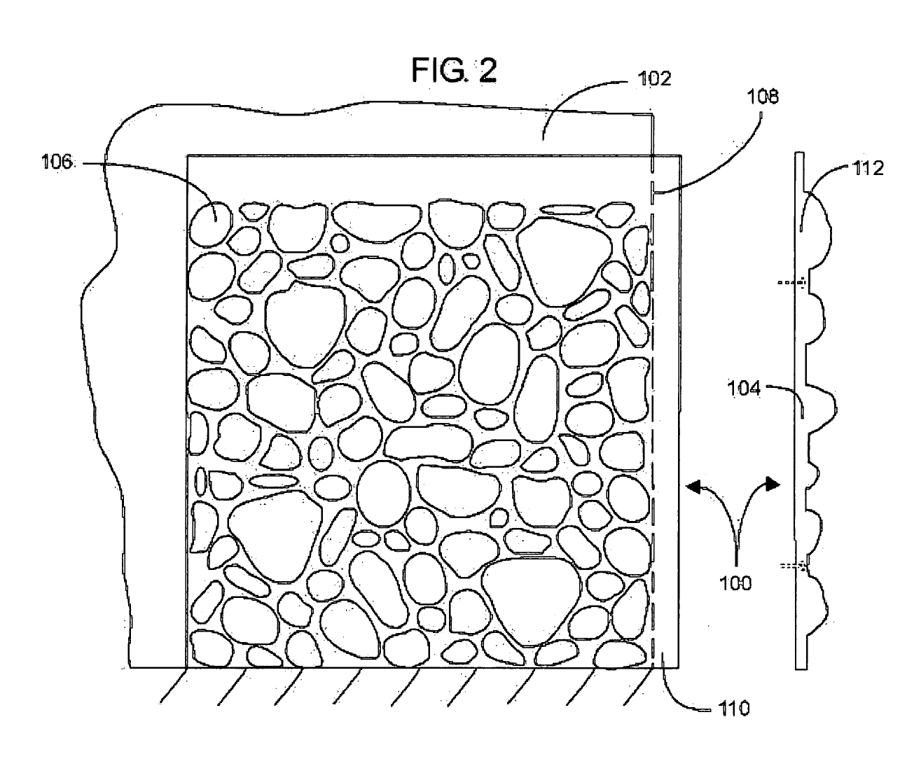

FIGS. 2-7 illustrate generally a manner in which the artificial wall 100 secures to an underlying structure 102. After the artificial wall 100 has been removed and touched-up, the dimensions of the underlying structure 102 are measured. Specifically, the height and the length of the underlying structure 102 are measured. The height, in this embodiment, is the distance from the top of the receiving portion of the underlying structure 102 to approximately three inches below ground. In another embodiment, the artificial wall 100 may be cut to varying heights and lengths. For instance, the artificial wall 100 may be cut to match a stair pattern.

Mark the dimensions on the artificial wall 100. Cut the artificial wall 100 according to the measured dimensions. The artificial wall 100 may be cut with any type of cutting tool capable of cutting polyurethane. Remove rock and dirt around the bottom of the underlying structure 102 approximately three inches deep. Place the artificial wall 100 against the underlying structure 102 and press the artificial wall 100 against the underlying structure 102. Using self-tapping screws 116, anchors, glue, or other securing means, and starting from one edge of the artificial wall 100, secure the artificial wall 100 to the underlying structure 102.

The artificial wall 100 may comprise at least a first artificial section 104 and a second artificial section 106 for securing each to adjoining sides of a corner 108 of a foundation 102. The steps for securing the first and second artificial sections 104 and 106 at the corner 108 of the underlying structure 102 are more difficult.

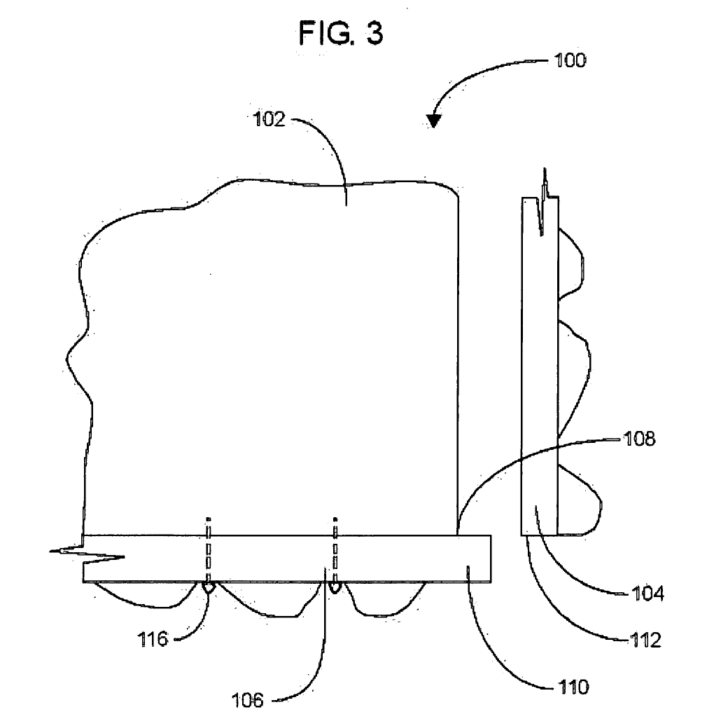

In one embodiment, the first artificial section 104 may be secured to the underlying structure 102, according to the steps described above, with one edge of the first artificial section 104 being flush with the corner 108 of the underlying structure 102. In another embodiment, the first artificial section 104 may be trimmed to be flush with the corner 108 of the underlying structure 102 after it has been secured to the underlying structure 102. In the illustrated embodiment in FIGS. 2 and 3, the first artificial section 104 may be secured to the underlying structure 102 after the second artificial section 106 has been secured to the underlying structure 102. The second artificial section 106 is secured to the underlying structure 102 with one end overhanging (“overhanging section 110”) the corner of the underlying structure 102, thus effectively covering the corner edge of the first artificial section 104.

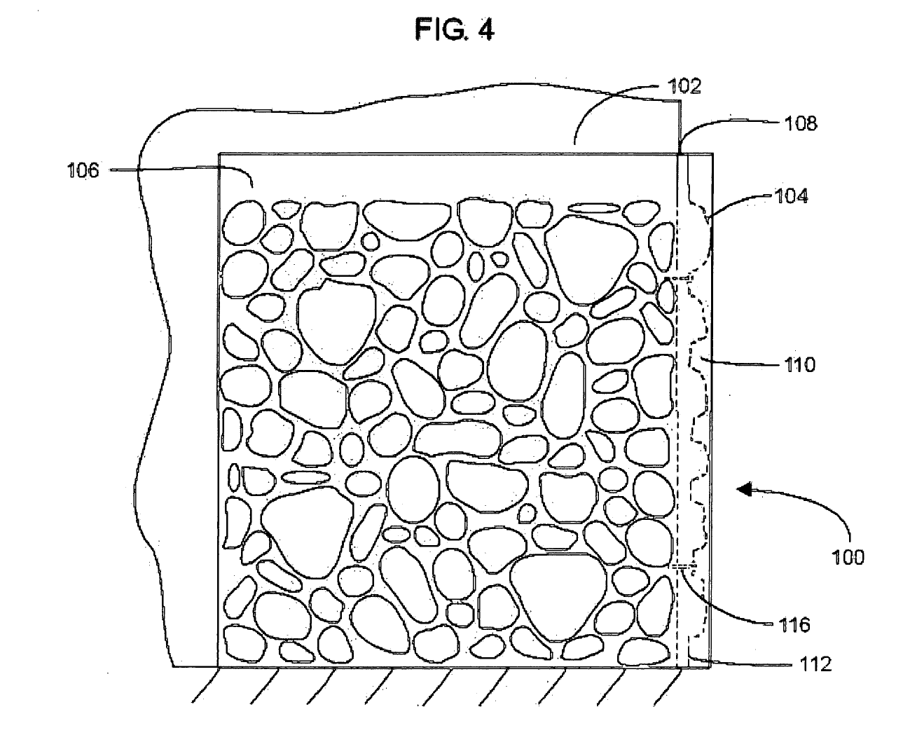

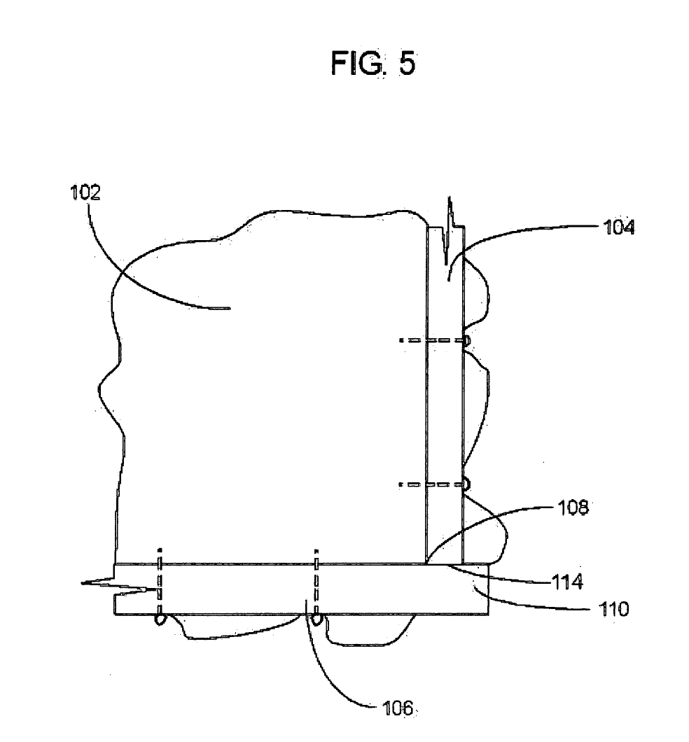

Referring to FIGS. 4 and 5, where the first and second artificial sections 104 and 106 meet, trace an outline of an edge 112 of the first artificial section 104 on aback side of the overhanging section 110 of the second artificial section 106. Using a cutting tool, cut the second artificial wall 106 according to the traced outline made on the back side of the second artificial section 106. Secure the first artificial section 104 to the second artificial section 106 where they overlap. In one embodiment, the second artificial section 106 may be cut according to the outline traced on the second artificial section 106 before being secured to the first artificial section 106.

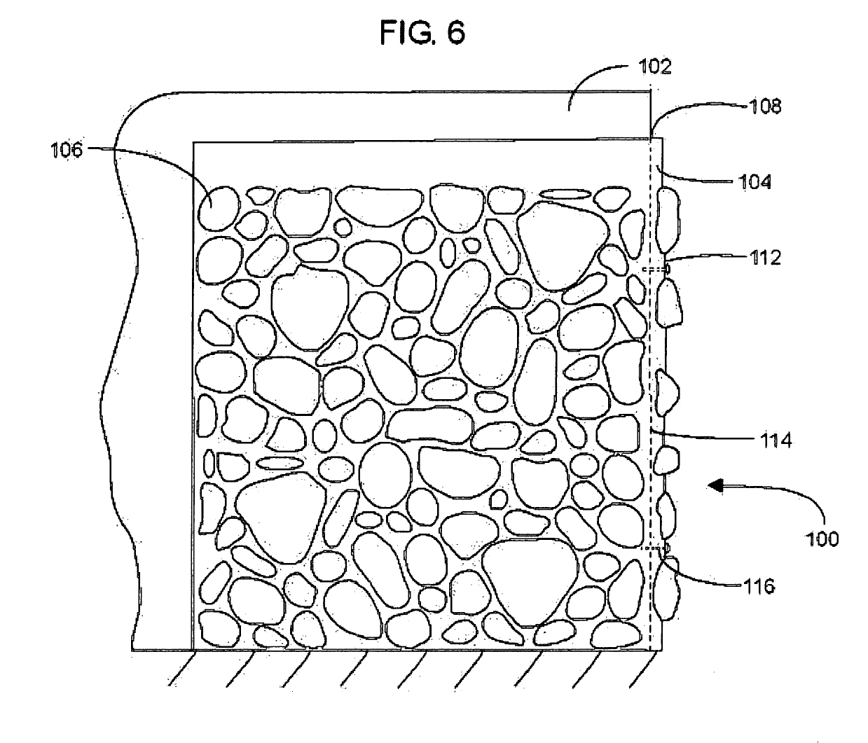

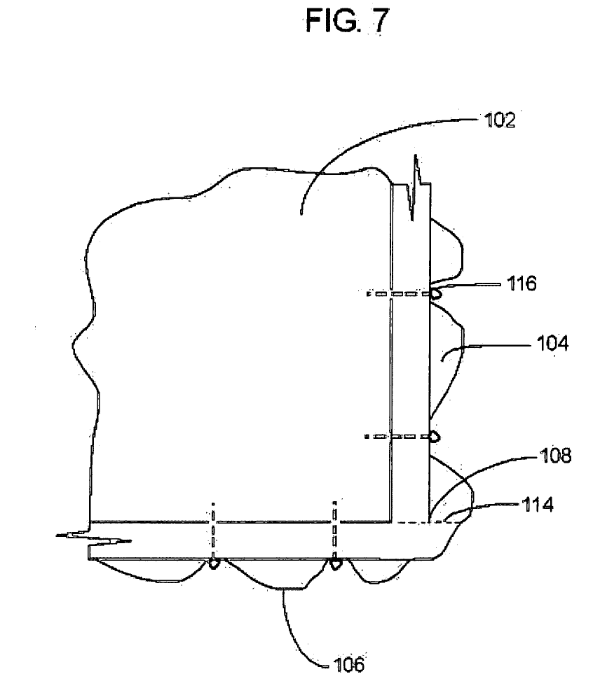

Referring now to FIGS. 6 and 7, a seem 114 exists at the corner 108 of the underlying structure 102 between the first and second artificial sections 104 and 106 where the first and second artificial sections 104 and 106 meet. Secure the first and second artificial sections 104 and 106 together at the seem 114. Polyurethane glue may be used, however, any type of glue capable of adhering the particular type of material is sufficient, such as caulk, silicone, etc. After the glue has cured, color the glue to match the color of the mortar, rocks, etc. In another embodiment, the glue may be premixed and dyed to predetermined colors. In another embodiment, the glue may be mixed with colored polyurethane pieces to match the color and texture of the first and second artificial sections 104 and 106.

Paint the overhanging section 110 of the second artificial section 106 to match the pattern of rocks on the first artificial section 104. Specifically, paint the second section 106 such that the rocks protruding from the first section 104, where the first and second artificial sections 104 and 106 meet, appear to extend from the second artificial section as well. Caulk and paint all screw heads 116 with paint that matches the painted portions of the first and second artificial sections 104 and 106. Replace dirt and rocks back against the artificial wall 100.

It is understood that the above-described arrangements are only illustrative of the application of the principles of the present invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the specification discusses the use of screws 116 to fasten the artificial wall 100 to the underlying structure, it is envisioned that any type of securing means may be used, such as glue, spikes, clamps, clasps, etc.

Additionally, although the specification discusses the use of patterns giving the appearance of natural rock, it is envisioned that any type of pattern, characters, shapes, and forms may be used, such as ornamental designs, geometric patterns, cartoon characters, animals, cars, trucks, airplanes, scenery, animals, words, letters, numbers, etc. Similarly, although the specification discusses generally the use of the artificial wall 100 for foundations of homes, it is envisioned that the artificial walls 100 may be adapted to be used on all types of structures, including, but not limited to mobile homes, fences, ceilings, walls, floors, etc. For mobile homes, or other areas that may benefit from artificial walls 100 and that have voids instead of the underlying foundation described above, underlying foundations 102 may be constructed to fill the voids or the artificial wall 100 may be constructed to include an internal frame.

Additionally, although the specification discusses cutting the artificial wall 100 to match dimensions of the underlying structure 102, it is envisioned that the artificial wall 100 may include extending pieces integrated into the liner that may tuck under, or into, areas of the underlying structure 102. For instance, it is envisioned that extending pieces may be tucked underneath overlying side panels on a home, and holes may be dug deeper than three inches to bury excess pieces of the artificial wall 100.

Finally, it is envisioned that the artificial wall may be cut to accommodate extensions that protrude from the underlying structure 102 such as water faucets, lights, electrical panels, etc.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. An artificial cover for covering an underlying structure, comprising:
a first side with a three-dimensional rock pattern protruding from the first side; and
a second side configured to contact and attach to the underlying structure.

2. The artificial cover according to claim 1, wherein the artificial cover is comprised of polyurethane.

3. The artificial cover according to claim 1, wherein the underlying structure is a foundation of a home.

4. The artificial cover according to claim 1, wherein the underlying structure is a stair case.

5. The artificial cover according to claim 1, wherein the artificial cover attaches to the underlying structure with screws.

6. An artificial cover for covering an underlying structure, comprising:
a first artificial section with a three-dimensional rock pattern protruding therefrom, and configured to attach to the underlying structure;
a second artificial section with a three-dimensional rock pattern protruding therefrom, and configured to attach to the underlying structure;
wherein, the first artificial section and the second artificial section meet at a corner of the underlying structure and form a seem, and wherein the second artificial section overlaps an edge of the first artificial section.

7. The artificial cover according to claim 5, wherein the artificial cover is comprised of polyurethane.

8. The artificial cover according to claim 5, wherein the artificial cover is comprised of one of the group consisting of plastic, rubber, fiberglass, and carbon fiber.

9. The artificial cover according to claim 5, wherein the underlying structure is a foundation of a home.

10. The artificial cover according to claim 5, wherein the underlying structure is a stair case.

11. The artificial cover according to claim 5, wherein the artificial cover attaches to the underlying structure with screws.

12. A method for securing an artificial cover to an underlying structure comprising the steps of:
securing a first artificial section to a first side of the underlying structure such that an edge of the first artificial section is flush with a second side of the underlying structure, and wherein the first artificial section includes a three-dimensional pattern of artificial rocks protruding therefrom;
securing a second artificial section with a three-dimensional pattern of artificial rocks to the second side of the underlying structure, such that one end of the second artificial section overhangs the edge of the first artificial section that is flush with the second side of the underlying structure, wherein the first and second artificial sections meet at a corner to form a seam; and
trimming one end of the second artificial section such that the trimmed end of the second artificial section is flush with the first artificial section; and
applying a securing means to the seam for securing the first and second artificial sections; and wherin the securing means matches the appearance of the first and second artificial sections.

13. The method according to claim 12, wherein the securing means is glue.

14. The method according to claim 13, wherein the second artificial section is colored on the edge that overhangs the first artificial section to match the colors of the three-dimensional rock pattern protruding from the first artificial section.

15. The method according to claim 12, wherein the securing means is colored before being applied to the seam.

16. The method according to claim 12, wherein the securing means is mixed with pieces of the artificial wall before being applied to the seam.

17. The method according to claim 11, wherein the artificial cover is secured to the underlying structure with screws.

18. The method according to claim 17, further comprising the step of painting over the screws to match the color of the artificial wall.

19. The method according to claim 13, before the securing the first artificial section step, the steps of:
coating a mold with a urethane release;
coloring a pattern of the mold to give the pattern a natural look;
applying polyurethane to the mold to form a liner;
removing the liner from the mold;
touching up imperfections in the liner, if necessary; and
coating the liner with a protective coating.

20. The method according to claim 19, wherein the pattern is colored with alkyd based paint.
